(19) United States
(12) Patent Application Publication
(10) Pub. No.: US 2007/0191115 A1
(43) Pub. Date: Aug. 16, 2007

(54) Back-mounted battery for palm-top video game

(75) Inventor: Kai-Hun Lai, Taipei (TW)

Correspondence Address: BRUCE H. TROXELL, SUITE 1404, 5205 LEESBURG PIKE, FALLS CHURCH, VA, 22041, US

(73) Assignee: Sperry Corp.

(21) Appl. No.: 11/350,802

(22) Filed: Feb. 10, 2006

(51) Int. Cl. G06F 19/00

(52) U.S. Cl. 463/47

(57) ABSTRACT

A back-mounted battery is mounted to a rear side of a palm-top video game to supply power thereto. The battery includes a pivoted portion corresponding to a disk slot provided on the palm-top video game. When the pivoted portion of the battery is pivotally turned to a backward opened position, a player could conveniently access the disk slot and change a game disk without removing the whole battery from the video game. A U-shaped holding-down member is pivotally connected to and forward extended from a top of the battery to abut on an upper front surface of the video game, and thereby firmly hold the battery to the rear side of the video game.

### FIELD OF THE INVENTION

The present invention relates to a back-mounted battery for palm-top video game, and more particularly to a battery mounted to a rear side of a palm-top video game to supply power thereto without hindering a player from changing a game disk.

### BACKGROUND OF THE INVENTION

A palm-top video game has a small volume and is conveniently portable. The palm-top video game is powered by an internal battery, which can normally supply power for five consecutive hours. When the battery has previously been used, it would then work less than five hours next time. To avoid an exhausted battery while playing a game on the palm-top video game, a back-mounted battery for mounting to the back of the palm-top video game has been developed to provide an extended time of power supply.

FIGS. 1-1 and 1-2 are front and rear perspective views, respectively, of a general palm-top video game 20 available in the market, and FIG. 2 shows the video game 20 with a conventional back-mounted battery 10 mounted to a rear side thereof. The conventional back-mounted battery 10 is provided at a top with two forward extended tabs 11, each of which is provided at a bottom with a dot 12 for extending into a screw hole 22 located at each lateral side of a peripheral connecting socket 21 on a top of the video game 20, so as to fix the battery 10 to the rear side of the video game 20. The above-described back-mounted battery 10 has two disadvantages as below:
1. The battery 10 would shield a disk slot 23 provided at the rear side of the video game 20. When it is desired to change a game disk (not shown), a player has to remove the battery 10 from the video game 20 first. This is obviously inconvenient to the player to do so.
2. The screw holes 22 at two lateral sides of the peripheral connecting socket 21 on the video game 20 are occupied by the two dots 12 on the tabs 11 of the battery 10, preventing some type of peripheral from connecting to the video game via the peripheral connecting socket and accordingly, reducing the function of video game 20.

### SUMMARY OF THE INVENTION

A primary object of the present invention is to provide a back-mounted battery for palm-top video game, which need not be removed from the video game when a player wants to change a game disk.

Another object of the present invention is to provide a back-mounted battery for palm-top video game, which does not shield the screw holes on two lateral sides of the peripheral connecting socket on the video game, enabling the connection of a peripheral to the video game at any time.

To achieve the first object, the back-mounted battery for palm-top video game according to the present invention includes a pivoted portion corresponding to the disk slot on the palm-top video game. When the pivoted portion of the battery is pivotally turned to a backward opened position, the disk slot of the video game is exposed and accessible for changing a game disk.

To achieve the second object, the back-mounted battery for palm-top video game according to the present invention includes a carrier forward extended from a lower front edge of the battery for supporting the video game thereon, and a U-shaped holding-down member forward extended from a top of the battery to abut a lowered crossbar of the holding-down member on an upper front surface of the video game, so that the battery is firmly fixed to the rear side of the video game.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1-1 is a front perspective view of a general palm-top video game;

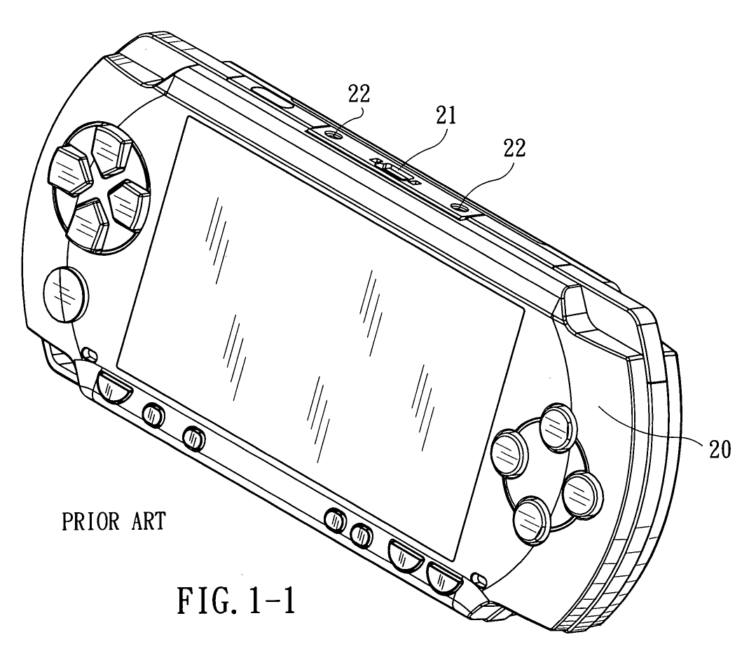

FIG. 1-2 is a rear perspective view of a general palm-top video game;

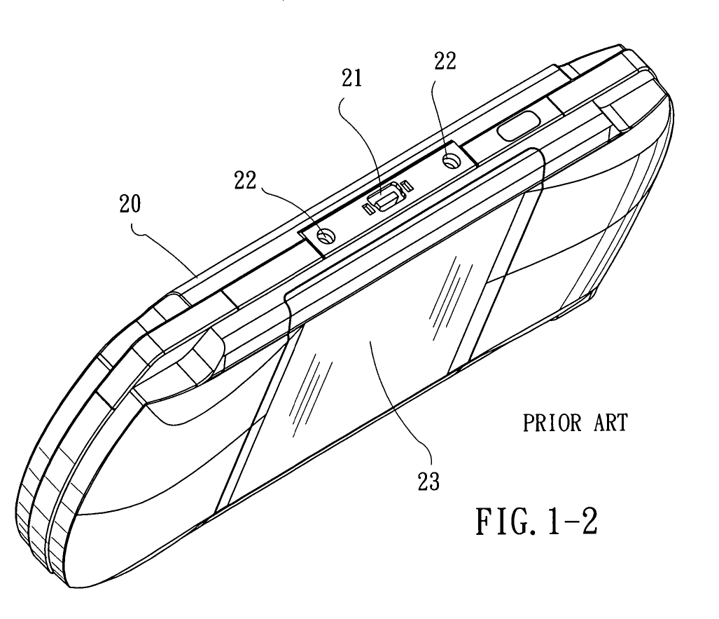

FIG. 2 shows the palm-top video game of FIGS. 1-1 and 1-2 with a conventional back-mounted battery mounted to a rear side of the video game;

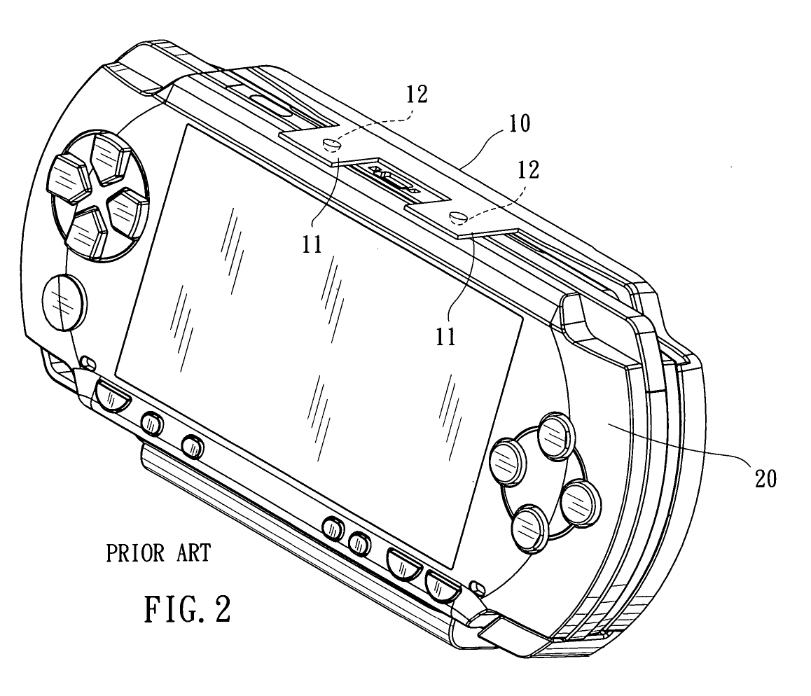

FIG. 3 is a front perspective view of a back-mounted battery for palm-top video game according to a preferred embodiment of the present invention;

FIG. 4 is a front perspective view of the back-mounted battery of FIG. 3 with a pivoted portion thereof in a backward opened position;

FIG. 5 is a rear perspective view of the back-mounted battery of FIG. 3 with the pivoted portion thereof in a backward opened position;

FIG. 6 shows a general palm-top video game with the back-mounted battery of FIG. 3 mounted to a rear side of the video game;

FIG. 7 is a rear view of FIG. 6 with the pivoted portion of the back-mounted battery in a backward opened position; and

FIG. 8 is a side view of FIG. 6 with a holding-down member of the back-mounted battery in a lifted position.

### DETAILED DESCRIPTION OF THE PREFERRED EMBODIMENTS

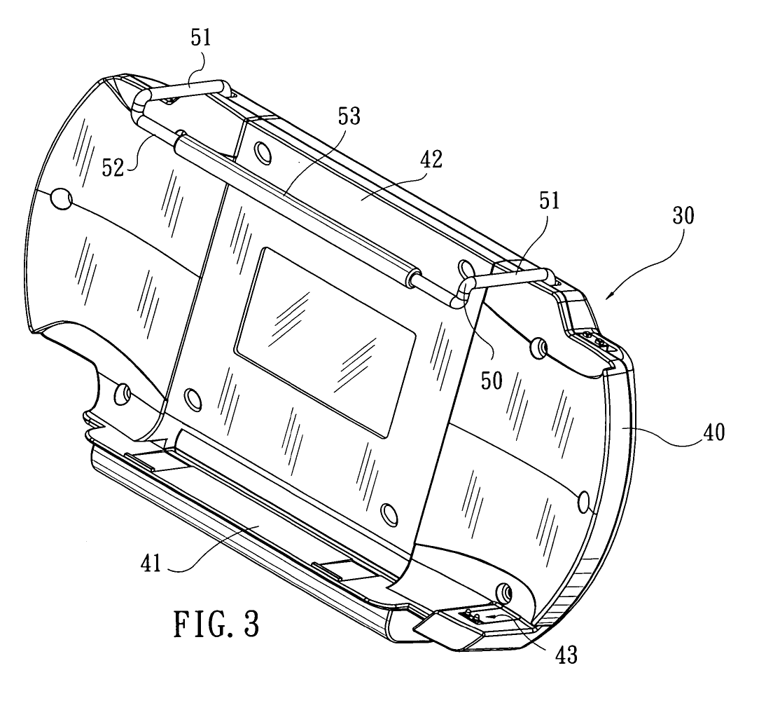

Please refer to FIG. 3 that is a front perspective view of a back-mounted battery for palm-top video game according to a preferred embodiment of the present invention.

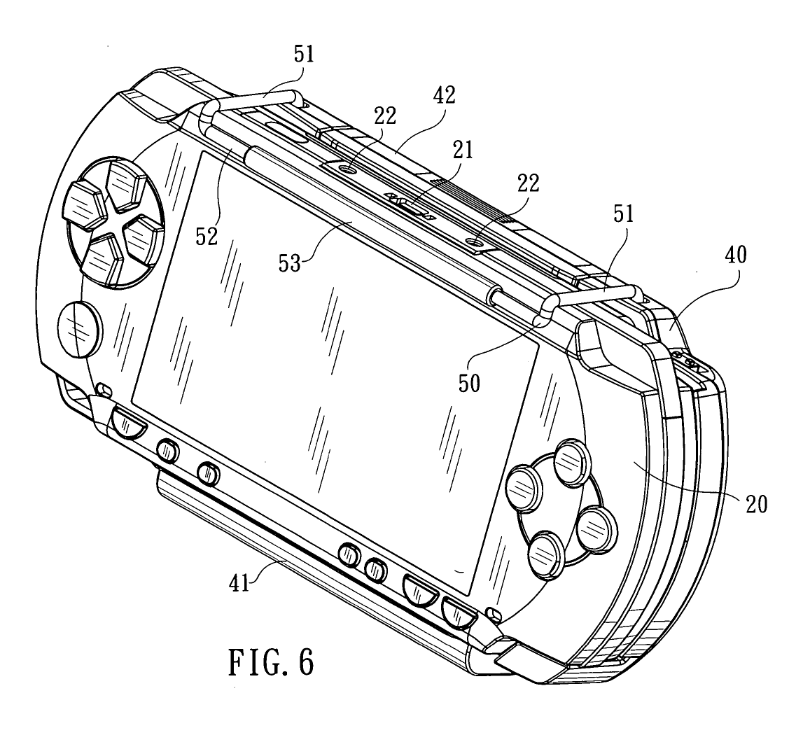

The back-mounted battery of the present invention, which is generally denoted a reference numeral 30, is designed for mounting to a rear side of a general palm-top video game 20, as shown in FIGS. 6, 7, and 8, so as to supply power to the video game 20. The back-mounted battery 30 includes a main body 40 and a substantially U-shaped holding-down member 50. The main body 40 has a front side configured to fitly attach to the rear side of the video game 20, so that a clearance between the video game 20 and the back-mounted battery 30 is minimized. The main body 40 includes a carrier 41 forward extended from a lower front edge of the main body 40 for supporting the video game 20 thereon. The U-shaped holding-down member 50 is pivotally turnably connected to a top of the main body 40 to forward extend therefrom. Thus, the whole video game 20 can be stably held to the back-mounted battery 30 between the carrier 41 of the main body 40 and the U-shaped holding-down member 50, as shown in FIG. 6.

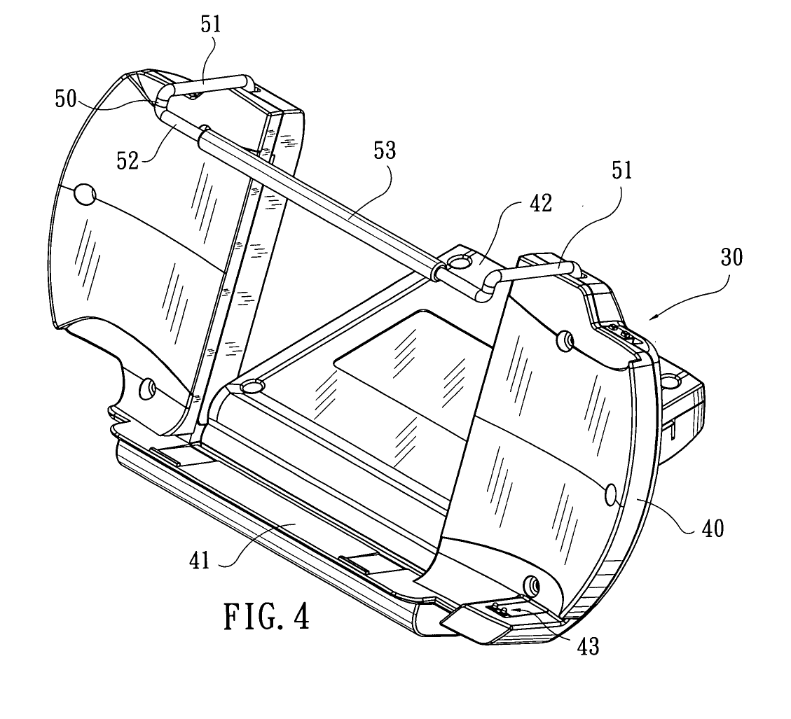

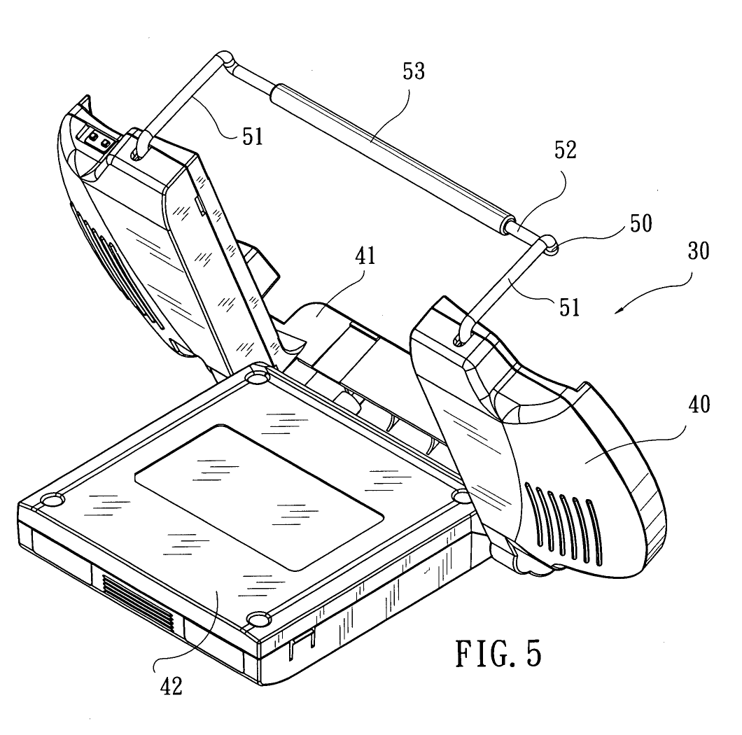

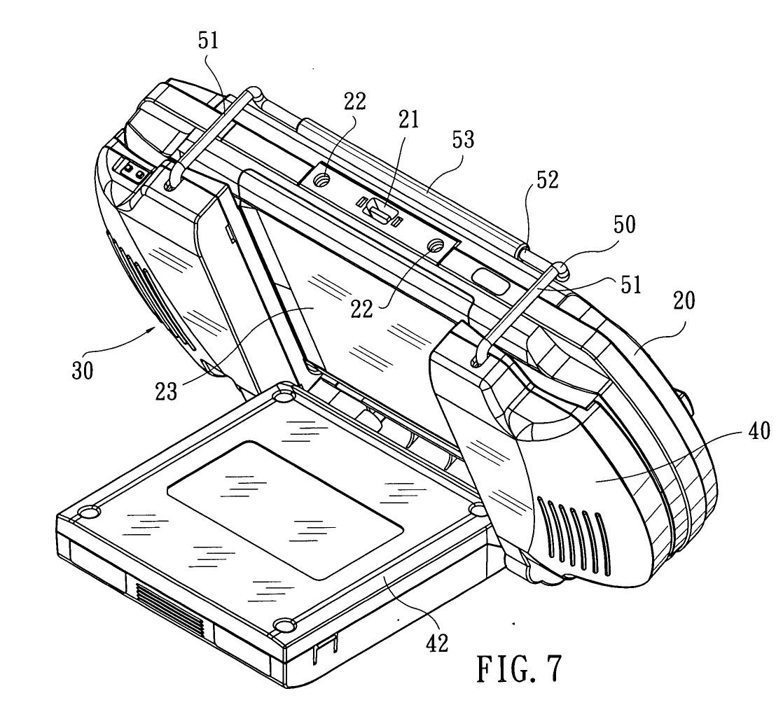

Please refer to FIGS. 4 and 5. The main body 40 of the battery 30 is provided near a central area with a pivoted portion 42, which is connected at a lower edge to the main body 40 via a pivot shaft (not shown) and can be backward turned about the pivot shaft. When the battery 30 is mounted to the rear side of the video game 20, the pivoted portion 42 is aligned with the disk slot 23 provided at the rear side of the video game 20. When the pivoted portion 42 is in a backward opened position, the disk slot 23 is fully exposed and conveniently accessible, as shown in FIG. 7. Therefore, a player could open the disk slot 23 and change a game disk (not shown) without removing the whole battery 30 from the video game 20.

The pivoted portion 42 is pivotally connected to the main body 40 in a conventional manner, such as using a pivot shaft and shaft holes. In the preferred embodiment of the present invention, the pivoted portion 42 is pivotally connected to the main body 40 through tight fitting, so that the rearward turned pivoted portion 42 is maintained in the opened position, unless a sufficient external force is forward applied thereto. The pivoted portion 42 in the opened position also serves to stably support the whole video game 20 and battery 30 on a desktop, enabling a player to operate the video game is an effortless manner.

The U-shaped holding-down member 50 is connected at two ends to the main body 40, so that two longitudinal arms 51 and one crossbar 52 of the U-shaped member 50 are located outside the battery 30. When the U-shaped holding-down member 50 is assembled to the main body 40, it is forward projected from the top of the main body 40. Please refer to FIG. 6. The crossbar 52 is relatively lower than the two longitudinal arms 51, so as to locate at and abut on an upper front surface of the video game 20 when the two longitudinal arms extend across the top of the video game 20, enabling a firm attachment of the battery 30 to the video game 20. The crossbar 52 of the U-shaped holding-down member 50 is provided on an outer surface with a soft tube 53, which protects the video game 20 against scraping by the crossbar 52 abutted on the upper front surface of the video game 20. Since the soft tube 53 is compressible, it provides improved holding down effect.

As can be clearly seen from FIG. 3, the battery 30 is provided on the main body 40 with a contact 43 serving as an output of power. When the battery 30 is attached to the rear side of the video game 20, the contact 43 is in contact with a power input (not shown) on the video game 20 to supply power from the battery 30 to the video game 20. Since this is a known technique and not a subject matter of the present invention, it is not discussed in details herein.

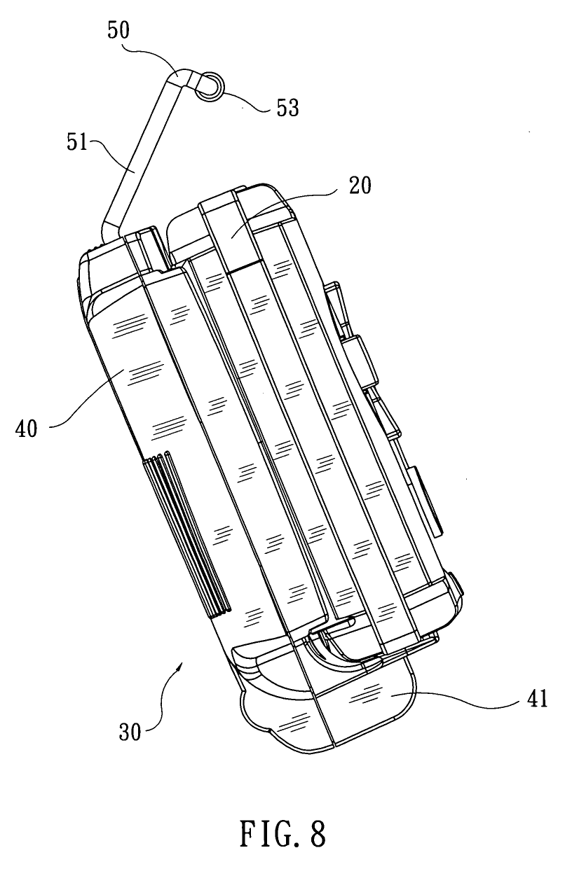

Please refer to FIG. 8 that is a side view FIG. 6 with the holding-down member 50 of the back-mounted battery 30 in a pivotally lifted position. With the holding-down member 50 in the lifted position, the video game 20 can be more easily positioned on the carrier 41 of the main body 40 of the battery 30. After the video game 20 has been positioned on the carrier 41, the holding-down member 50 is downward turned to abut it crossbar 52 on the upper front surface of the video game 20. As can be seen from FIG. 6, the U-shaped holding-down member 50 in the forward extended position to hold the video game 20 to the battery 30 would not hinder the screw holes 22 located at two lateral sides of the peripheral connecting socket 21 on the top of the video game 20, so that a signal cable of a peripheral (not shown) could be plugged in the connecting socket 21 at any time to connect the peripheral to the video game 20.

The back-mounted battery for palm-top video game according to the present invention is more conveniently for use because it has simple structure and allows the player to change the game disk without the need of removing the battery from the video game. Moreover, the back-mounted battery of the present invention also serves to stably support the palm-top video game on a desk top, and does not hinder a peripheral from connecting to the peripheral connecting socket provided on the video game.

What is claimed is:

1. A back-mounted battery for palm-top video game, comprising:
a main body including a carrier forward extended from a lower front edge thereof for supporting a palm-top video game thereon; and
a holding-down member turnably assembled to a top of said main body for abutting on an upper front surface of said palm-top video game supported on said carrier of said main body to thereby hold said main body to a rear side of said video game; and
said main body including a pivoted portion corresponding to a disk slot provided on said palm-top video game, such that said pivoted portion could be pivotally turned to a backward opened position to expose the disk slot for changing a game disk.

2. The back-mounted battery for palm-top video game as claimed in claim 1, wherein said pivoted portion is pivotally connected to said main body via a pivot shaft and shaft holes, and could therefore be turned about said pivot shaft to said backward opened position.

3. The back-mounted battery for palm-top video game as claimed in claim 2, wherein said pivoted portion is pivotally connected to said main body through tight fitting, and serves to stably support said palm-top video game on a planar surface when being pivotally turned to said backward opened position.

4. The back-mounted battery for palm-top video game as claimed in claim 1, wherein said holding-down member is a U-shaped member forward extended from a top of said main body, and includes two longitudinal arms and one crossbar; said crossbar being relatively lower than said longitudinal arms, so as to abut on said upper front surface of said video game when said two longitudinal arms extend across a top of the video game.

5. The back-mounted battery for palm-top video game as claimed in claim 4, wherein said U-shaped holding-down member includes a soft tube put around said crossbar.
